(19) United States
(12) Patent Application Publication
(10) Pub. No.: US 2013/0248583 A1
(43) Pub. Date: Sep. 26, 2013

(54) REFLOW INSPECTION SYSTEM AND CONTROL METHOD THEREOF

(71) Applicants: Yun Bog Kim, Gyunggi-do (KR); Young Ju Lee, Gyunggi-do (KR); Seon Young Myoung, Gyunggi-do (KR); Suk Jin Ham, Gyunggi-do (KR); Seong Chan Park, Gyunggi-do (KR); Hyun Jung Lee, Gyunggi-do (KR)

(72) Inventors: Yun Bog Kim, Gyunggi-do (KR); Young Ju Lee, Gyunggi-do (KR); Seon Young Myoung, Gyunggi-do (KR); Suk Jin Ham, Gyunggi-do (KR); Seong Chan Park, Gyunggi-do (KR); Hyun Jung Lee, Gyunggi-do (KR)

(73) Assignee: SAMSUNG ELECTRO-MECHANICS CO., LTD., Gyunggi-do (KR)

(21) Appl. No.: 13/532,482

(22) Filed: Jun. 25, 2012

(30) Foreign Application Priority Data
Mar. 20, 2012 (KR) 1020120028274

(51) Int. Cl. B23K 31/12; H04N 7/18

(52) U.S. Cl. 228/105; 348/87; 348/E07.085

(57) ABSTRACT

Disclosed herein is a reflow inspection system. The reflow inspection system according to an embodiment of the present invention includes an oven, a stage on which a reflow inspection target is placed inside the oven, and which includes a temperature detecting sensor for detecting a temperature of the reflow inspection target formed on one side thereof; a light source unit formed on one side of the oven and irradiating the reflow inspection target with light, an imaging unit sucking smoke generated in the reflow inspection target, and obtaining image information of the reflow inspection target to thereby transmit the obtained image information to the outside, an image processing unit processing the image information obtained in the imaging unit, and a control unit connected to the stage, the temperature detecting sensor, and the image processing unit to perform control of a reflow inspection process.

### CROSS REFERENCE TO RELATED APPLICATION

This application claims the benefit of Korean Patent Application No. 10-2012-0028274, filed on Mar. 20, 2012, entitled “Reflow Inspection Apparatus and Control Method Thereof”, which is hereby incorporated by reference in its entirety into this application.

### BACKGROUND OF THE INVENTION

1. Technical Field

The present invention relates to a reflow inspection system and a control method thereof

2. Description of the Related Art

With the development of the electronic industry, a semiconductor device having a high speed processing rate and a high degree of integration has been required, and therefore a circuit product needs to be produced with an element size of a submicron unit. According to these requirements, technology development for an exposure apparatus having high resolution and a light-sensitive photoresist composition has been carried out even in a lithography technology field. In particular, attempts to increase dimensional accuracy of a pattern with respect to a structure having a minimum feature size have been made.

In order to manufacture a highly integrated semiconductor device, a photoresist pattern used as a mask of an etching and ion implantation process is required to be formed in a more precise and minute manner. For this, a photoresist which is sensitive to light is required; however, complex additional processes are accompanied when using a light-sensitive photoresist.

A wavelength of a light source of the exposure apparatus is directly related to a minimum resolution that can be obtained. For example, an existing G-line (λ=435 nm) exposure apparatus has a resolution limitation of approximately 0.5 μm, and an I-line (λ=365 nm) exposure apparatus has a resolution limitation of approximately 0.3 μm. In addition, a light source of KrF(λ=248 nm) may be used to implement a critical dimension (CD) of approximately 0.15 μm, while research for ArF(λ=193 nm) has been continuously conducted to manufacture a device of 0.13 μm or less.

However, according to device design rules of recent years, it can be expected that a resolution limitation of the current exposure apparatus is further reduced than the above described resolution limitation, and therefore technology development that can overcome limitations of the current exposure apparatus is required.

In particular, when manufacturing a highly-integrated device that includes a minute contact hole having a high aspect ratio in a cell array region having a pattern or a device having a minute CD, a variety of processing technologies for overcoming the resolution limitation of the current exposure apparatus have been developed.

As an example of these processing technologies, a reflow technique which includes, for example, a photoresist reflow technique disclosed in Korean Patent Laid-Open Publication No. 2008-0060080 (laid-open published on Jul. 1, 2008) and a solder paste reflow technique disclosed in Korean Patent Publication No. 10-0739089 (registered on Jul. 6, 2007) may be given.

First, a resist reflow technique is a method of forming a line and space (L/S) with a desired CD or a contact hole with a desired size in a manner such that a photoresist forming a minute pattern is heated in order to be fluidized, that is, is subjected to reflow.

The resist reflow technique will be described in detail as below. An initial photoresist pattern is formed in a manner such that a CD or contact hole of a final L/S pattern is larger than a desired size. In general, the desired size is smaller than the resolution limitation of the exposure apparatus to be used. Subsequently, the initial photoresist pattern is heated up to a temperature equal to or higher than a glass transition temperature Tg of the photoresist, so that the photoresist of the photoresist pattern is allowed to be fluidized, that is, to be subjected to reflow. That is, viscosity of the photoresist is reduced by the heating, so that the photoresist is subjected to reflow, thereby causing a reduction in a size of an opening of the CD or the contact hole of the L/S pattern. As a result, a desired minute pattern may be obtained.

Subsequently, in the solder paste reflow technique, a solder paste in a melt state is applied on a substrate in a predetermined pattern, and various kinds of small-sized electronic components such as semiconductor chips, resistance chips, and the like are bonded to the substrate by high-temperature delivery, so that the small-sized electronic components are surface mounted on the substrate.

The above described application process of the solder paste is performed by a solder paste coating device, for example, a “screen printer”, and the screen printer presses, using a squeeze, a solder paste supplied on a metal mask in which an opening with a specific pattern is formed, and applies the pressed solder paste on a component mounting unit of a printed circuit board.

In other words, a solder paste application structure in the prior art is a structure of applying a solder paste on a predetermined position using a solder mask in which a slit or a hole is processed in order to apply a predetermined pattern or the solder paste with a predetermined amount on a surface mounting printed circuit board. Therefore, by putting the solder paste with a predetermined amount on the solder mask and scratching the solder paste using a squeeze made of a rubber material, the solder paste is infiltrated into the slit or the hole of the solder mask, and thereby a solder paste pattern is formed on a copper foil of the printed circuit board.

Thereafter, when the mask is separated from the circuit board, and then the solder paste is subjected to a reflow process by raising a temperature under a nitrogen atmosphere, the solder paste is formed as a hemispherical solder bump.

Subsequently, the various kinds of small-sized electronic components such as semiconductor chip, resistance chips, or the like are mounted on the substrate by the solder bump.

In such reflow techniques, performances of the photoresist or the solder paste such as an eutectic point, wettability at the vicinity of the eutectic point, and the like are the most important factors which are directly related to a formation condition of the minute pattern or the bump.

However, there is almost no device that can measure a melting phenomenon momentarily generated during the reflow inspection process of the photoresist or the solder paste, or a change on a surface or an interface of the photoresist or the solder paste. In addition, when an organic solvent, an organic adhesive, or the like is mixed as is in the solder paste, it is difficult to secure visibility due to smoke generated at the time of heating, and therefore performance inspection of the photoresist or the solder paste in real time is almost impossible.

### SUMMARY OF THE INVENTION

The present invention has been made in an effort to provide a reflow inspection system which may inspect reflow performance while removing smoke generated during a reflow inspection process.

The present invention has also been made in an effort to provide a control method of a reflow inspection system which may inspect reflow performance while removing smoke generated during a reflow inspection process.

According to a preferred embodiment of the present invention, there is provided a reflow inspection system, including: an oven; a stage on which a reflow inspection target is placed inside the oven, and which includes a temperature detecting sensor for detecting a temperature of the reflow inspection target formed on one side thereof; a light source unit formed on one side of the oven and irradiating the reflow inspection target with light; an imaging unit sucking smoke generated from the reflow inspection target, and obtaining image information of the reflow inspection target to thereby transmit the obtained image information to the outside; an image processing unit processing the image information obtained in the imaging unit; and a control unit connected to the stage, the temperature detecting sensor, and the image processing unit to perform control of a reflow inspection process.

The oven may include a plurality of introduction inlets introducing reflow gas for heating the reflow inspection target, and a plurality of discharge outlets discharging gas after the reflow inspection process.

The imaging unit may include a camera unit transmitting, to the image processing unit via an optical fiber, light incident via an opening in which lens are provided, and a suction tube protrudingly provided at a region adjacent to the opening, and connected to a suction pump connected with the control unit in the outside.

The suction tube is protruded by a length shorter than a focal distance of the lens, and an end portion of the suction tube has an inclined cut surface with a predetermined acute angle in a protrusion direction.

The control unit may control operations of the suction pump in accordance with brightness of the image information received from the image processing unit.

The control unit may be connected to the temperature detecting sensor and the image processing unit to thereby receive reflow inspection information of the reflow inspection target in real time.

According to another preferred embodiment of the present invention, there is provided a control method of a reflow inspection system, including: placing a reflow inspection target on a stage inside an oven; performing reflow on the reflow inspection target in accordance with a reflow inspection processing condition for reflow performance inspection; detecting, by a control unit, information concerning the reflow inspection target in real time; determining, by the control unit, whether the detected information concerning the reflow inspection target is excellent information in which reflow performance is able to be inspected; repeatedly detecting, in real time, the information concerning the reflow inspection target in a final manner while sucking smoke generated in the reflow inspection target, in accordance with a result of the determination; and inspecting the reflow performance of the reflow inspection target using the information concerning the reflow inspection target having been finally detected.

In the detecting of the information concerning the reflow inspection target in real time, image information and temperature information of the reflow inspection target may be detected, in real time, by using: an imaging unit which includes a camera unit transmitting, to an image processing unit via an optical fiber, light incident via an opening in which lens are provided, and a suction tube protrudingly provided at a region adjacent to the opening, and connected to a suction pump connected with the control unit in the outside; and a temperature detecting sensor provided on one side of the stage.

In the determining whether the detected information is excellent information, the control unit may determine whether image brightness of the reflow inspection target detected in real time through the image processing unit is lower than initial image brightness of the reflow inspection target.

In the determining whether the detected information is excellent information, the determining whether the detected information is excellent information may be performed on the basis of 90% of the initial image brightness of the reflow inspection target.

The repeatedly detecting, in real time, of the information concerning the reflow inspection target in a final manner may include sucking the smoke generated in the reflow inspection target through an inclined cut surface formed at an end portion of the suction tube.

The inspecting the reflow performance may include detecting a contact width (D) and a contact angle (θ) from the image information of the reflow inspection target having been finally detected.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic diagram showing a configuration of a reflow inspection system according to an embodiment of the present invention;

FIG. 2 is an enlarged diagram obtained enlarging an imaging unit of FIG. 1;

FIG. 3 is a flowchart showing a control method of a reflow inspection system according to another embodiment of the present invention;

FIGS. 4A and 4B are diagrams for explaining a control method of a reflow inspection system according to another embodiment of the present invention; and

FIG. 5 is a diagram for explaining a reflow inspection in accordance with a control method according to another embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

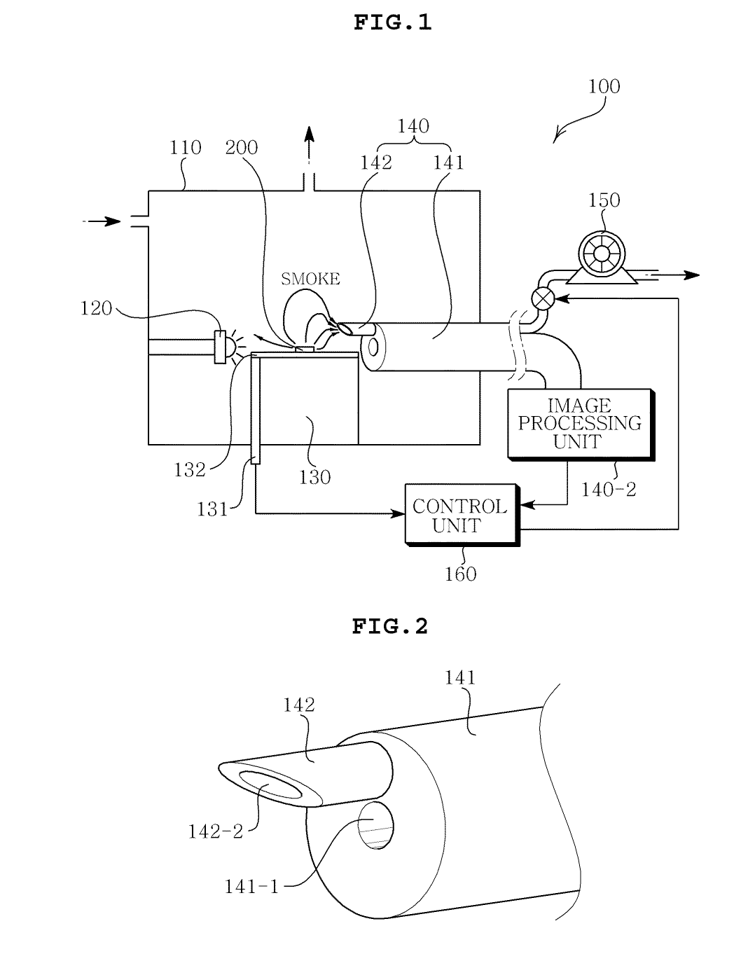

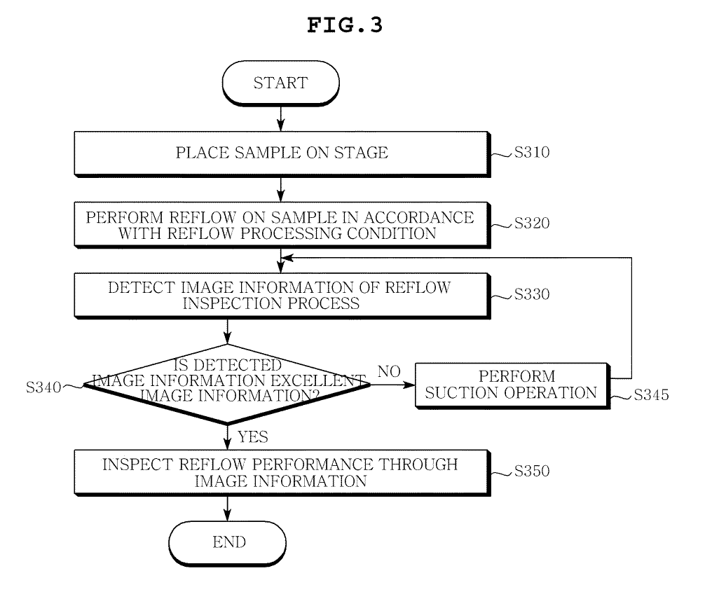

FIG. 1 is a schematic diagram illustrating a configuration of a reflow inspection system according to an embodiment of the present invention, and FIG. 2 is an enlarged diagram obtained enlarging an imaging unit of FIG. 1.

As shown in FIG. 1, a reflow inspection system 100 according to an embodiment of the present invention includes an oven 110, a stage 130 on which a reflow inspection target 200 is placed inside the oven 110 and which includes a temperature detecting sensor 131 for detecting a temperature of the reflow inspection target 200 formed on one side thereof, an imaging unit 140 which corresponds to a light source unit 120 formed on one side of the oven 110 and irradiating the reflow inspection target 200 with light, and obtains image information of the reflow inspection target 200 to thereby transmit the obtained image information to the outside, an image processing unit 140-2 which processes the image information obtained in the imaging unit 140, and a control unit 160 which is connected to an adjustment valve, or the like of the stage 130 to thereby perform overall control, the temperature detecting sensor 131, the image processing unit 140-2, and a suction pump 150.

Here, as the reflow inspection target 200, a sample of an electronic component to which a reflow inspection process is applied, and for example, a sample in a state in which a photoresist, a solder paste, or the like is formed on a substrate before the reflow inspection process may be used

The oven 110 includes a plurality of introduction inlets introducing reflow gas for heating the reflow inspection target 200 in accordance with inspection conditions, and a plurality of discharge outlets discharging gas after the reflow inspection process. Here, as the reflow gas introduced to the oven 110, inert gas such as nitrogen gas, argon gas, or the like, which is preheated to a predetermined temperature so as to heat the reflow inspection target 200 in accordance with the inspection conditions to thereby be introduced may be used.

The oven 110 may include a heat source such as a heater, or the like provided therein without the reflow gas, and thereby may heat the reflow inspection target 200.

The stage 130 includes a metal plate 132 for placing the reflow inspection target 200 on an upper surface of the metal plate 132 inside the oven 110, and the temperature detecting sensor 131 for detecting a temperature of the reflow inspection target 200 formed on one side thereof The stage 130 may be moved along X, Y, and Z axes by control of the control unit 160, for example, using a vibration motor, or the like, and may be moved to a position in which the reflow inspection target 200 can be readily imaged.

In addition, the temperature detecting sensor 131 may be brought into contact with the metal plate 132 on one side of the stage 130, and detect, in real time, the temperature of the reflow inspection target 200 which is heat-conducted along the metal plate 132. To more accurately detect the temperature of the reflow inspection target 200, the temperature detecting sensor 131 may be brought into contact with a substrate of the reflow inspection target 200, and thereby detect a melting temperature of the photoresist or the solder paste by heat conduction phenomenon.

The imaging unit 140 is mounted to correspond to the light source unit 120 formed on one side with respect to the stage 130 on which the reflow inspection target 200 is placed inside the oven 110, and is connected to the image processing unit 140-2 and the suction pump 150 in the outside.

Specifically, the imaging unit 140 has a structure of an ultra-compact camera as shown in FIG. 2, and includes an ultra-compact camera unit 141 which has an opening 141-1 in which lens are provided, and a suction tube 142 which is protrudingly provided in a region adjacent to the opening 141-1 and connected to the suction pump 150.

The imaging unit 140 may transmit, to the image processing unit 140-2 via an optical fiber, light incident via the lens of the opening 141-1, and selectively includes a separate light source in another region adjacent to the opening 141-1 to thereby irradiate the reflow inspection target 200 with light.

In addition, the imaging unit 140 includes the suction tube 142 which is protruded to the outside by a predetermined length in such a manner as to be adjacent to the opening 141-1, so that smoke generated in the reflow inspection process with respect to the reflow inspection target 200 is sucked using the suction tube 142 by control of the control unit 160.

Accordingly, the imaging unit 140 removes the smoke using the suction tube 142 to thereby improve visibility in the reflow inspection process of the reflow inspection target 200, obtains the image information of the reflow inspection target 200 through the lens of the opening 141-1 to thereby transmit the obtained image information to the image processing unit 140-2 in the outside.

In particular, the suction tube 142 is protruded by a length shorter than a focal distance of the lens of the opening 141-1, and a shape of an end portion of the suction tube 142 is formed of an inclined cut surface 142-2 with a predetermined acute angle in a protrusion direction so as to readily perform removal of the smoke. The inclined cut surface 142-2 of the suction tube 142 is positioned on the upper and lower sides and on the left and right sides with respect to the opening 141-1, in proximity to the reflow inspection target 200, and thereby sucks the smoke of the reflow inspection target 200 generated during the reflow inspection process.

The control unit 160 performs overall control of the reflow inspection system 100, and particularly, is connected to an adjustment valve, or the like of the stage 130, the temperature detecting sensor 131, the image processing unit 140-2, and the suction pump 150 to thereby perform control of the reflow inspection process.

In particular, when the image information transmitted through the image processing unit 140-2 is determined as error image information on which reflow inspection cannot be performed due to the smoke, the control unit 160 activates the suction pump 150 to thereby suck and remove the smoke through the suction tube 142.

The reflow inspection system 100 according to an embodiment of the present invention which is configured as above prevents imaging with respect to the reflow inspection target 200 from being interrupted due to the smoke generated in the reflow inspection target 200 using the suction tube 142.

Accordingly, the reflow inspection system 100 according to an embodiment of the present invention may readily inspect reflow performance of the reflow inspection target 200 while removing the smoke generated during the reflow inspection process.

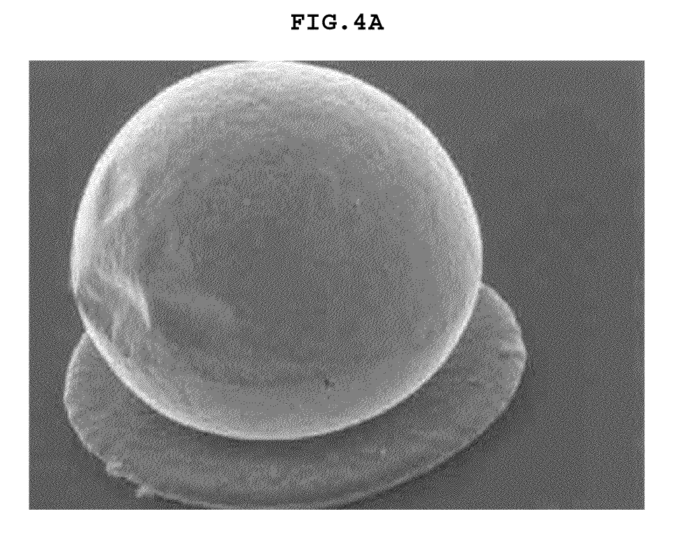

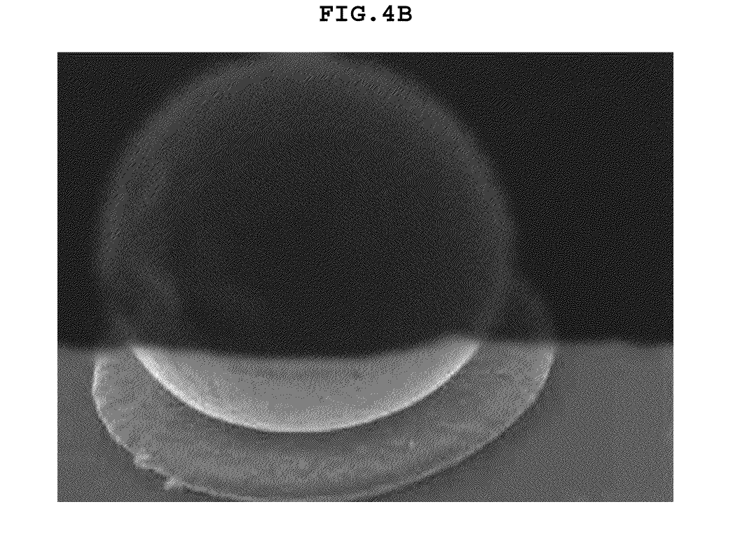

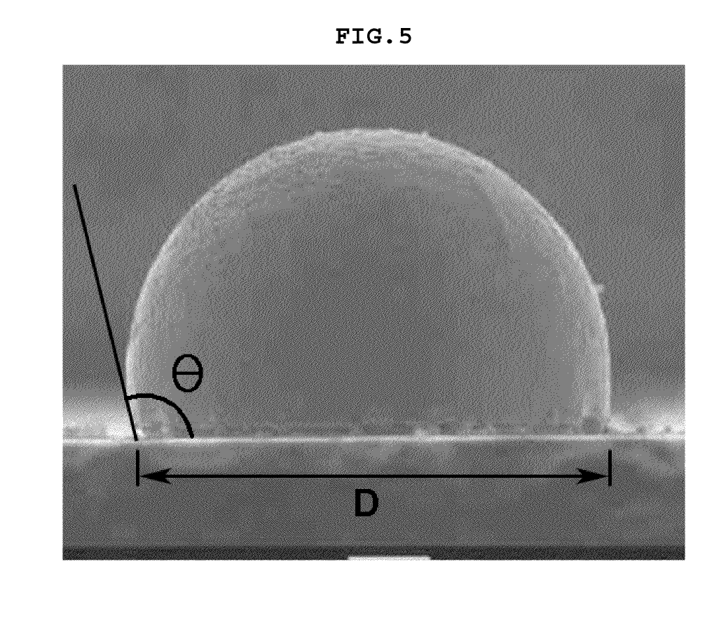

Hereinafter, a control method of the reflow inspection system 100 according to another embodiment of the present invention will be described with reference to FIGS. 3 through 5. FIG. 3 is a flowchart showing a control method of a reflow inspection system according to another embodiment of the present invention, FIGS. 4A and 4B are diagrams for explaining a control method of a reflow inspection system according to another embodiment of the present invention, and FIG. 5 is a diagram for explaining reflow inspection in accordance with a control method according to another embodiment of the present invention.

The control method of the reflow inspection system 100 according to another embodiment of the present invention is a control method related to a process of inspecting reflow performance of the reflow inspection target 200, and first mount the reflow inspection target 200 on the stage 130 in step S310.

Here, as the reflow inspection target 200, a sample of an electronic component to which a reflow inspection process is applied, and for example, a sample in a state in which photoresist, a solder paste, or the like is formed on a substrate before the reflow inspection process may be used

In this instance, the reflow inspection target 200 is mounted so as to be brought into contact with the temperature detecting sensor 131 mounted on one side of the stage 130, so that temperature information of the reflow inspection target 200 that is detected by the temperature detecting sensor 131 in real time is transmitted to the control unit 160.

In addition, the imaging unit 140 is mounted in proximity to the reflow inspection target 200, and particularly, an inclined cut surface of the suction tube 142 is mounted in proximity to the reflow inspection target 200.

The reflow inspection target 200 is subjected to reflow in accordance with reflow inspection processing conditions for reflow performance inspection after the reflow inspection target 200 is placed on the stage 130 (S320).

The reflow inspection processing condition may include various processing conditions, and for example, include a condition for a heating temperature where the reflow process is performed. In other words, using inert gas such as nitrogen gas, argon gas, or the like, which is preheated to a predetermined temperature so as to heat the reflow inspection target 200 to thereby be introduced to the oven 110, or using heating equipment such as a heater, or the like which is provided inside the oven 110, an atmospheric temperature of the oven 110 may be raised to a predetermined reflow heating temperature condition.

After the reflow is performed on the reflow inspection target 200 in accordance with the reflow inspection processing conditions, the control unit 160 detects image information of the reflow inspection target 200 in real time using the imaging unit 140 and the image processing unit 140-2 (S330).

The control unit 160 may detect an image of the reflow inspection target 200, such as an image shown in FIG. 4A, even before performing reflow with respect to the reflow inspection target 200 using the imaging unit 140 and the image processing unit 140-2. FIG. 4A shows an image of the initial status of inspection target 200 like a substrate wherein a solder ball is mounted, prior to conducting the reflow. It is taken from the imaging unit 140. FIG. 4B shows an image taken from the imaging unit 140 whose view is blocked by the smoke incurred during the process of conducting the reflow of inspection target 200.

After the image information of the reflow inspection target 200 is detected in real time, the control unit 160 determines whether the detected image information is excellent image information where the reflow performance of the reflow inspection target 200 can be inspected (S340).

In other words, the smoke generated in the reflow inspection target 200 while performing the reflow with respect to the reflow inspection target 200 blocks light incident via the opening 141-1 of the imaging unit 140, and therefore, whether the imaging unit 140 detects the excellent image information may be determined.

Accordingly, when brightness of the image detected using the imaging unit 140 and the image processing unit 140-2 is detected as being lower than initial image brightness before performing the reflow, for example, being 90% or less of the initial image brightness, the control unit 160 determines whether the detected image information is not the excellent image information, and activates the suction pump 150 to enable the suction tube 142 to suck the smoke (S345).

Thereafter, when the suction tube 142 sucks the smoke, the control unit 160 repeatedly detects the image information the reflow inspection target 200 in real time using the imaging unit 140 and the imaging processing unit 140-2.

On the other hand, when the detected image information is the excellent image information where the reflow performance of the reflow inspection target 200 can be inspected in step 5340, the control unit 160 inspects the reflow performance of the reflow inspection target 200 from the detected image information (S350).

For example, the control unit 160 may inspect a melting starting temperature, a reflow time, wettability, and the like as items for inspecting the reflow performance.

In detail, the control unit 160 may receive, from the temperature detecting sensor 131, temperature information at a point of time when the photoresist, the solder paste, or the like of the reflow inspection target 200 is melted during the reflow inspection process, and detect the melting starting temperature.

In addition, the control unit 160 may place the reflow inspection target 200 on the stage 130, and detect reflow time information from time information which is detected in real time from a point of time immediately before performing the reflow to a point of time immediately after performing the reflow.

In particular, the control unit 160 may detect a contact width (D), a contact angle (θ), and the like of the solder paste from image information, shown in FIG. 5, of the solder paste detected after performing the reflow to thereby inspect the wettability.

Thereafter, the control unit 160 may display inspection results of the reflow performance on a display unit such as a monitor, or the like, as reflow performance information of the reflow inspection target 200.

Accordingly, in the control method of the reflow inspection system 100 according to another embodiment of the present invention, the smoke generated during the reflow inspection process of inspecting the reflow performance of the reflow inspection target 200 may be removed to improve visibility, thereby readily obtaining the image information where the reflow performance can be inspected.

As a result, in the control method of the reflow inspection system 100 according to another embodiment of the present invention, it is possible to readily inspect the reflow performance of the reflow inspection target 200 using highly reliable image information in which visibility of the reflow inspection process is improved.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A reflow inspection system, comprising:
an oven;
a stage on which a reflow inspection target is placed inside the oven, and which includes a temperature detecting sensor for detecting a temperature of the reflow inspection target formed on one side thereof;
a light source unit formed on one side of the oven and irradiating the reflow inspection target with light;
an imaging unit sucking smoke generated from the reflow inspection target, and obtaining image information of the reflow inspection target to thereby transmit the obtained image information to the outside;
an image processing unit processing the image information obtained in the imaging unit; and
a control unit connected to the stage, the temperature detecting sensor, and the image processing unit to perform control of a reflow inspection process.

2. The reflow inspection system as set forth in claim 1, wherein the oven includes a plurality of introduction inlets introducing reflow gas for heating the reflow inspection target, and a plurality of discharge outlets discharging gas after the reflow inspection process.

3. The reflow inspection system as set forth in claim 1, wherein the imaging unit includes:
a camera unit transmitting, to the image processing unit via an optical fiber, light incident via an opening in which lens are provided, and
a suction tube protrudingly provided at a region adjacent to the opening, and connected to a suction pump connected with the control unit outside.

4. The reflow inspection system as set forth in claim 3, wherein the suction tube is protruded by a length shorter than a focal distance of the lens, and an end portion of the suction tube has an inclined cut surface with a predetermined acute angle in a protrusion direction.

5. The reflow inspection system as set forth in claim 3, wherein the control unit controls operations of the suction pump in accordance with brightness of the image information received from the image processing unit.

6. The reflow inspection system as set forth in claim 1, wherein the control unit is connected to the temperature detecting sensor and the image processing unit to thereby receive reflow inspection information of the reflow inspection target in real time.

7. A control method of a reflow inspection system, comprising:
placing a reflow inspection target on a stage inside an oven;
performing reflow on the reflow inspection target in accordance with a reflow inspection processing condition for reflow performance inspection;
detecting, by a control unit, information concerning the reflow inspection target in real time;
determining, by the control unit, whether the detected information concerning the reflow inspection target is excellent information in which reflow performance is able to be inspected;
repeatedly detecting, in real time, the information concerning the reflow inspection target in a final manner while sucking smoke generated in the reflow inspection target, in accordance with a result of the determining; and
inspecting the reflow performance of the reflow inspection target using the information concerning the reflow inspection target having been finally detected.

8. The control method as set forth in claim 7, wherein in the detecting of the information concerning the reflow inspection target in real time, image information and temperature information of the reflow inspection target are detected, in real time, by using :
an imaging unit which includes a camera unit transmitting, to an image processing unit via an optical fiber, light incident via an opening in which lens are provided, and a suction tube protrudingly provided at a region adjacent to the opening, and connected to a suction pump connected with the control unit in the outside; and
a temperature detecting sensor provided on one side of the stage.

9. The control method as set forth in claim 8, wherein in the determining whether the detected information is excellent information, the control unit determines whether image brightness of the reflow inspection target detected in real time through the image processing unit is lower than initial image brightness of the reflow inspection target.

10. The control method as set forth in claim 9, wherein in the determining whether the detected information is excellent information, the determining whether the detected information is excellent information is performed on the basis of 90% of the initial image brightness of the reflow inspection target.

11. The control method as set forth in claim 8, wherein the repeatedly detecting, in real time, of the information concerning the reflow inspection target in a final manner includes sucking the smoke generated in the reflow inspection target through an inclined cut surface formed at an end portion of the suction tube.

12. The control method as set forth in claim 8, wherein the inspecting the reflow performance includes detecting a contact width (D) and a contact angle (θ) from the image information of the reflow inspection target having been finally detected.
